(19) United States
(12) Patent Application Publication
(10) Pub. No.: US 2004/0251864 A1
(43) Pub. Date: Dec. 16, 2004

(54) Apparatus and method for controlling brushless DC motor

(75) Inventor: Hyun Rok Cha, Kwangju-City (KR)

Correspondence Address: Ladas & Parry, 26 West 61st Street, New York, NY, 10023, US

(73) Assignee: SAMSUNG GWANG JU ELECTRONICS CO., LTD.

(21) Appl. No.: 10/635,357

(22) Filed: Aug. 6, 2003

(30) Foreign Application Priority Data
Jun. 13, 2003 (KR) 2003-38385

(51) Int. Cl. H02P 7/50

(52) U.S. Cl. 318/439; 318/798

(57) ABSTRACT

An apparatus and method for controlling a brushless DC motor, which allows an ignition phase current to be ignited in advance by advancing an ignition time of the ignition phase current by a certain time, thus providing a sufficiently increased phase current is provided to the brushless DC motor during an actual phase commutation period. According to the present invention, the insufficiency of a phase current generated during the phase commutation period is compensated for, thus reducing torque ripple of the brushless DC motor occurring at the time of a phase commutation.

### CROSS-REFERENCE TO RELATED APPLICATION

This application claims the benefit of Korean Application No. 2003-38385, filed Jun. 13, 2003, in the Korean Intellectual Property Office, the disclosure of which is incorporated herein by reference.

### BACKGROUND OF THE INVENTION

1. Field of the Invention

The present invention relates, in general, to an apparatus and method for controlling motors and, more particularly, to an apparatus and method for controlling a brushless direct current motor, which minimizes torque ripple.

2. Description of the Related Art

Generally, a brushless Direct Current (DC) motor employs a rectifying circuit including switching devices instead of mechanical elements, such as a brush and a commutator. The brushless DC motor is characterized in that the replacement of the brush due to abrasion is not necessary, and little electromagnetic interference exists.

When the conventional brushless DC motor is driven, torque ripple is generated due to a temporary decrease in phase current while phase commutation of polyphase Alternating Current (AC) power is carried out. That is, torque of the brushless DC motor may be expressed by a product of an induced voltage and a current. During a phase commutation period, a phase current temporarily decreases, thus generating torque ripple. Since the torque ripple is a cause of noise generation and vibration, an apparatus and method to minimize the torque ripple is required.

### SUMMARY OF THE INVENTION

Accordingly, it is an aspect of the present invention to provide an apparatus and method for controlling a brushless DC motor, which minimizes torque ripple of the brushless DC motor generated at a time of a phase commutation by compensating for insufficiency of a phase current generated during a phase commutation period.

Additional aspects and/or advantages of the invention will be set forth in part in the description which follows and, in part, will be obvious from the description, or may be learned by practice of the invention.

The above and/or other aspects are achieved by providing an apparatus to control a brushless Direct Current (DC) motor equipped with a rotator, the apparatus including a converting unit to convert Alternating Current (AC) power to, polyphase AC power and supply the polyphase AC power to the brushless DC motor, a rotator operation detecting unit to detect operation information of the rotator, and a control unit to predict a phase commutation time of the polyphase AC power and control an ignition time of an ignition phase current to be earlier than the phase commutation time.

The above and/or other aspects are achieved by providing a method to control a brushless DC motor, which predicts an ignition phase commutation time of the polyphase AC power using operation information of the rotator, and controls an ignition time of an ignition phase current to be earlier than the phase commutation time.

### BRIEF DESCRIPTION OF THE DRAWINGS

These and other aspects and advantages of the invention will become apparent and more readily appreciated from the following description of the preferred embodiments, taken in conjunction with the accompanying drawings of which:

FIG. 1 is a block diagram of an apparatus for controlling a brushless DC motor, according to the present invention;

FIGS. 2 and 3A to 3C are waveform diagrams showing phase communication characteristics of the brushless DC motor of FIG. 1;

FIG. 4 is a flowchart of a method of controlling a brushless DC motor, according to the present invention; and

FIGS. 5 and 6 are graphs showing current characteristics of a conventional brushless DC motor and the brushless DC motor of the present invention, respectively.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

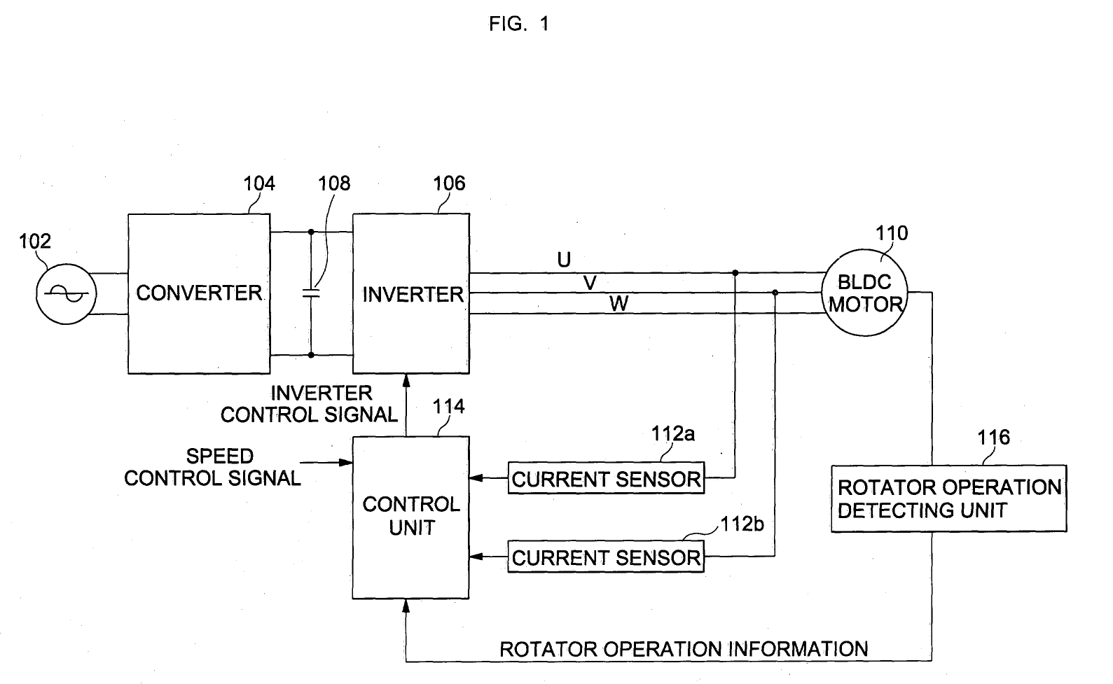

FIG. 1 is a block diagram of an apparatus for controlling a brushless DC motor, according to the present invention. As shown in FIG. 1, a power converting unit including a converter 104, a capacitor 108 and an inverter 106 converts AC power supplied from an AC power supply unit 102 to pulse-shaped 3-phase (U, V and W) AC power, and supplies the 3-phase AC power to a brushless DC motor 110. Intensities of respective phase currents of the 3-phase (U, V and W) AC power, supplied to the brushless DC motor 110 from the inverter 106, are detected by first and second current sensors 112a and 112b. The information of the detected phase currents is provided to a control unit 114, and an inverter control signal is based on the detected phase current information. A rotator operation detecting unit 116 detects a position and rotational speed of a rotator of the brushless DC motor 110 and provides the detected results to the control unit 114. The inverter control signal is also based on the rotator operation information provided to the control unit 114. The control unit 114 controls the rotational speed of the brushless DC motor 110 with reference to a speed control signal input from an outside of the brushless DC motor control apparatus, the phase current information, the rotator operation information and the like to comply with a requirement of the speed control signal.

The inverter control signal generated by the control unit 114 is used to control a phase commutation time of the 3-phase (U, V and W) AC power output from the inverter 106. Especially, an intensity of an ignition phase current at an actual phase commutation time is sufficiently increased by advancing an ignition time of the ignition phase current when required, thus compensating for insufficiency of a phase current generated during a phase commutation period. Consequently, torque ripple of the brushless DC motor maybe reduced.

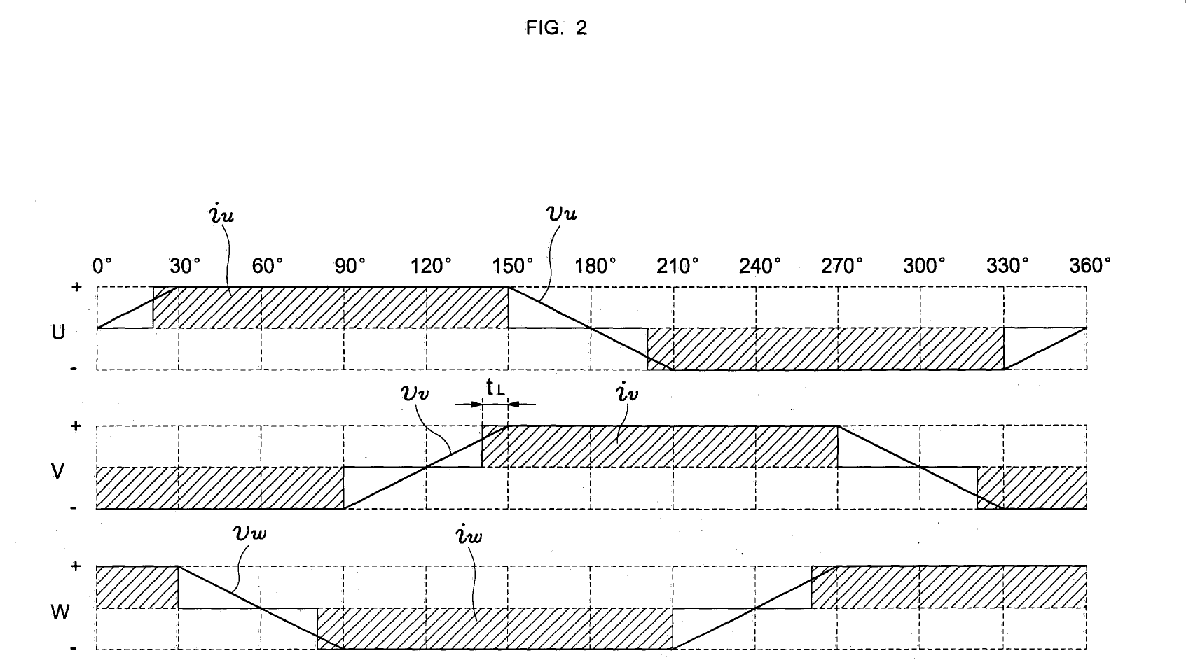

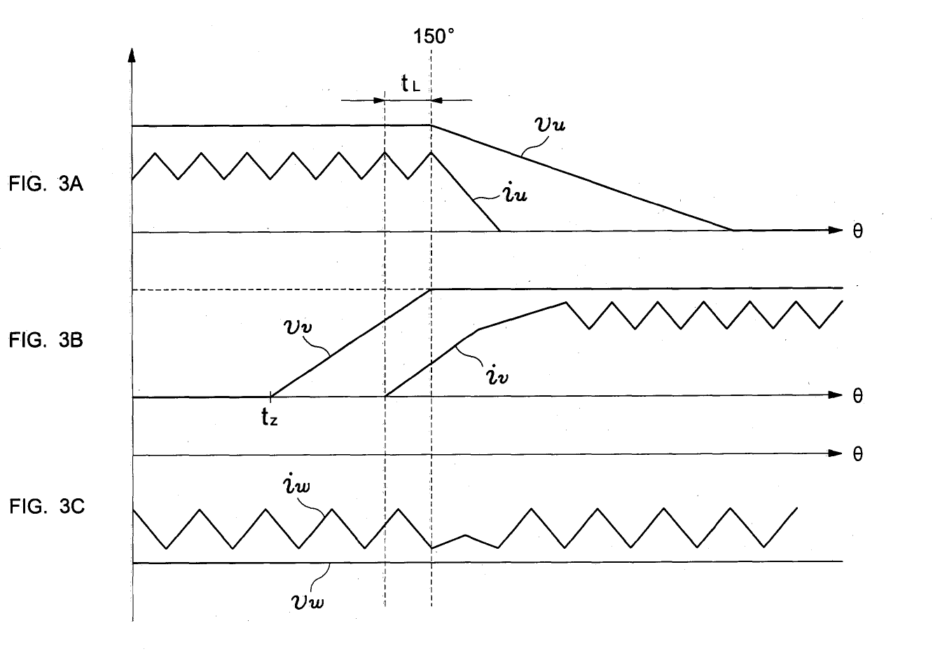

FIGS. 2 and 3A to 3C are waveform diagrams showing phase communication characteristics of the brushless DC motor of FIG. 1. Referring to FIG. 2, a phase commutation time of a brushless DC motor operating by typical 3-phase AC power is a time when a phase commutation completely occurs, which corresponds to 30°, 90°, 150°, 210°, 270° and 330°. On the contrary, when the brushless DC motor of the present invention is controlled, the ignition phase current is ignited at times earlier than 30°, 90°, 150°, 210°, 270° and 330°, respectively, by a time tL by advancing the ignition time thereof. Therefore, at times of 30°, 90°, 150°, 210°, 270° and 330° when the phase commutation actually occurs, the intensity of the ignition phase current is sufficiently increased, thus reducing torque ripple of the brushless DC motor caused by temporary insufficiency of a phase current.

Referring to FIG. 3B, a zero crossing point tZ of an ignition phase voltage Vv is detected, and an ignition time of an ignition phase current iv is advanced by a time tL from 150° with reference to a current rotational speed of the rotator, thus allowing the ignition phase current iv to be ignited earlier than 150°. Therefore, at an actual phase commutation time of 150°, insufficiency of a phase current generated during the phase commutation period is compensated for by the ignition phase current increased in advance by some degrees, thus reducing torque ripple caused by the insufficiency of the phase current.

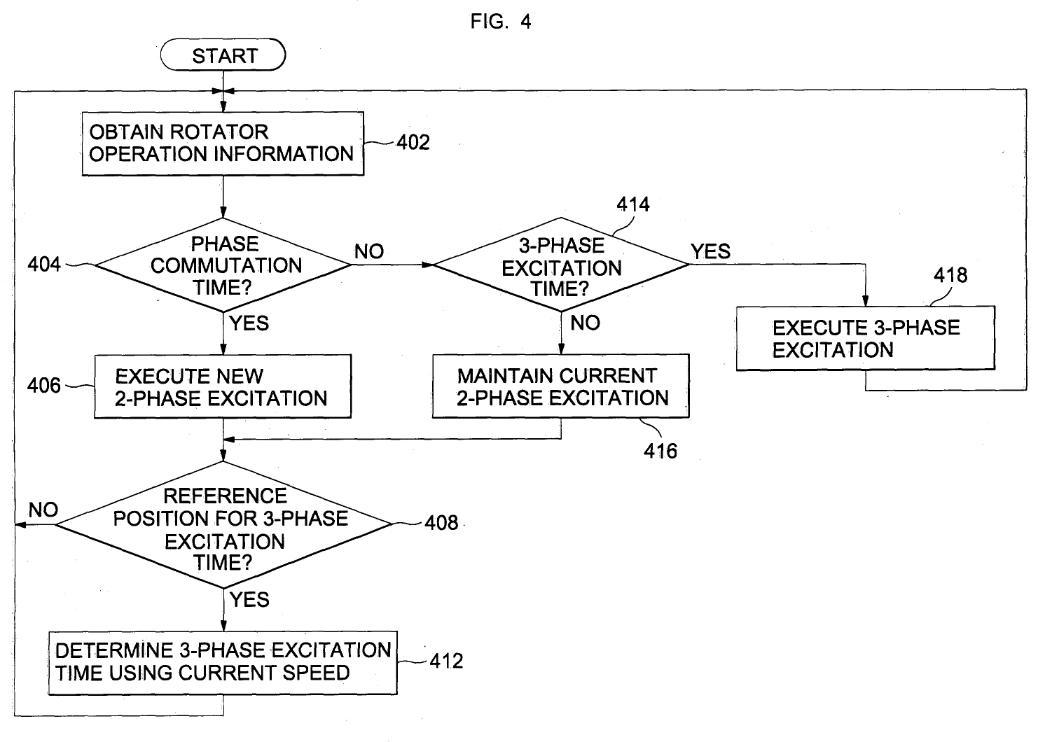

FIG. 4 is a flowchart of a method of controlling a brushless DC motor, according to the present invention. As shown in FIG. 4, operation information of the rotator is obtained by the rotator operation detecting unit 116 in operation 402, and it is determined whether a current time is a phase commutation time using the rotator operation information in operation 404. If it is determined that the current time is the phase commutation time, phase commutation is performed to execute a new 2-phase excitation in operation 406. After the new 2-phase excitation is executed, it is determined whether a current position is a reference position for a 3-phase excitation time in operation 408. The 3-phase excitation time reference position is a reference position to determine an ignition time by predicting a phase commutation time of an ignition phase current. The 3-phase excitation time reference position may be determined by utilizing a zero crossing point of an ignition phase voltage, or setting a separate reference position and utilizing a current sensor or the like. If the current position is not a 3-phase excitation time reference position, the method returns to the rotator operation information obtaining operation 402, while if the current position is the 3-phase excitation time reference position, a current speed of the rotator is calculated and the 3-phase excitation time is determined based on the current speed of the rotator in operation 412.

If the current time is not a phase commutation time in operation 404, it is determined whether the current time has reached a 3-phase excitation time in operation 414. If the current time has not reached a 3-phase excitation time, the method returns to the 3-phase excitation time reference position determining operation 408 while maintaining the current 2-phase excitation state in operation 416. If the current time has reached the 3-phase excitation time, the 3-phase excitation is executed to reduce torque ripple caused by the insufficiency of a phase current generated during a phase commutation period in operation 418.

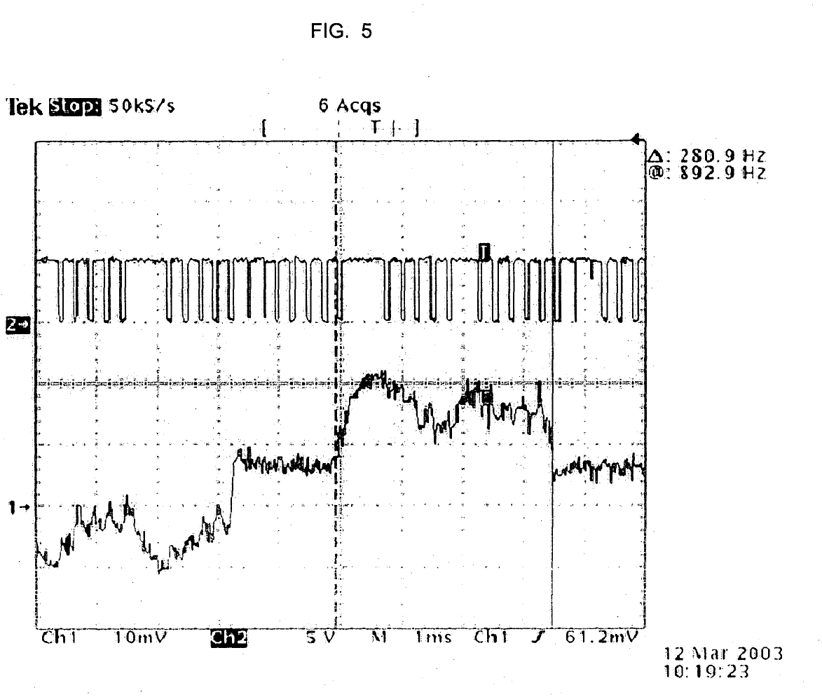

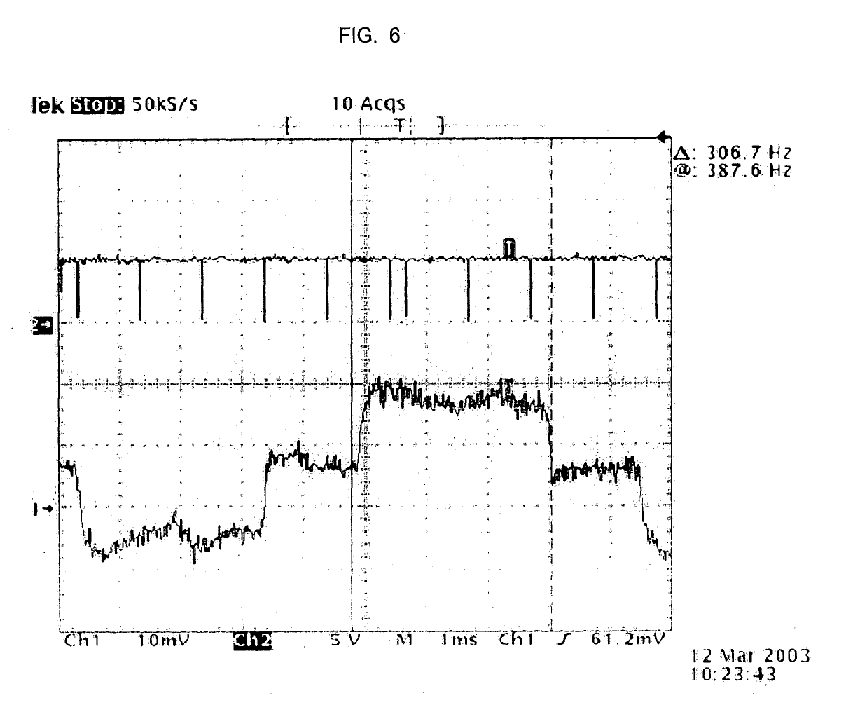

FIGS. 5 and 6 are graphs showing current characteristics of a conventional brushless DC motor and the brushless DC motor of the present invention, respectively. It may be seen that a current waveform is not uniform during a phase commutation period of the conventional brushless DC motor in FIG. 5, while a current waveform is relatively uniform during a phase commutation period of the brushless DC motor of the present invention in FIG. 6.

As apparent from the above description, the present invention provides an apparatus and method for controlling a brushless DC motor, which allows an ignition phase current to be ignited in advance by advancing an ignition time of the ignition phase current by a certain time, thus providing a sufficiently increased phase current to the brushless DC motor at an actual phase commutation time. Consequently, the present invention compensates for insufficiency of a phase current generated during a phase commutation period, thus reducing torque ripple of the brush less DC motor occurring at the time of a phase commutation.

Although a preferred embodiment of the present invention has been shown and described, it would be appreciated by those skilled in the art that changes may be made in these embodiments without departing from the principles and spirit of the invention, the scope of which is defined in the claims and their equivalents.

What is claimed is:

1. An apparatus to control a brushless Direct Current (DC) motor equipped with a rotator, the apparatus comprising:
a converting unit to convert Alternating Current (AC) power to polyphase AC power and supply the polyphase AC power to the brushless DC motor;
a rotator operation detecting unit to detect operation information of the rotator; and
a control unit to predict a phase commutation time of the polyphase AC power and control an ignition time of an ignition phase current to be earlier than the phase commutation time.

2. The brushless DC motor control apparatus according to claim 1, wherein the control unit predicts the phase commutation time of the polyphase AC power using either the operation information of the rotator or variation information of the polyphase AC power supplied to the brushless DC motor, or both.

3. The brushless DC motor control apparatus according claim 2, wherein the operation information of the rotator is either position information or speed information of the rotator, or both.

4. The brushless DC motor control apparatus according to claim 2, wherein the variation information of the polyphase AC power is zero crossing point detection information of an ignition phase voltage supplied to the brushless DC motor.

5. The brushless DC motor control apparatus according to claim 1, wherein the control unit controls all phase currents of the polyphase AC power, supplied to the brushless DC motor, to be conducted during a period between the ignition time of the ignition phase current and the phase commutation time.

6. The brushless DC motor control apparatus according to claim 1, wherein the converting unit comprises:
a converter to convert the AC power to DC power;
an inverter to convert the DC power to the polyphase AC power; and
a capacitor to connect between the converter and the inverter.

7. The brushless DC motor control apparatus according to claim 6, wherein the control unit controls the ignition time of the ignition phase current supplied to the brushless DC motor by generating an inverter control signal and outputting the inverter control signal to the inverter.

8. A method to control a brushless DC motor equipped with a rotator and supplied with polyphase AC power, the method comprising:
predicting an ignition phase commutation time of the polyphase AC power using operation information of the rotator; and
controlling an ignition time of an ignition phase current to be earlier than the phase commutation time.

9. The brushless DC motor control method according to claim 8, wherein the phase commutation time of the polyphase AC power is predicted using either the operation information of the rotator or variation information of the polyphase AC power supplied to the brushless DC motor, or both.

10. The brushless DC motor control method according claim 9, wherein the operation information of the rotator is either position information or speed information of the rotator, or both.

11. The brushless DC motor control method according to claim 9, wherein the variation information of the polyphase AC power is zero crossing point detection information of an ignition phase voltage supplied to the brushless DC motor.
